(19) United States
(12) Patent Application Publication
(10) Pub. No.: US 2026/0037699 A1
(43) Pub. Date: Feb. 5, 2026

(54) METHOD FOR DESIGING CAPACITY OF COMPRESSED GAS ENERGY STORAGE SYSTEM

(71) Applicant: Shandong University, Jinan (CN)

(72) Inventors: Qie SUN, Jinan (CN); Wei WANG, Jinan (CN); Cuiping MA, Jinan (CN); Tianrun YANG, Jinan (CN); Haoyu XIAO, Jinan (CN)

(73) Assignee: Shandong University, Jinan (CN)

(21) Appl. No.: 19/356,100

(22) Filed: Oct. 11, 2025

(30) Foreign Application Priority Data
Oct. 15, 2024 (CN) 202411440460.6

(51) Int. Cl. G06F 30/27; G06F 111/04; G06F 119/06; G06Q 30/0201; G06Q 50/06

(52) U.S. Cl. CPC G06F 30/27; G06Q 30/0206; G06Q 50/06; G06F 2111/04; G06F 2119/06

(57) ABSTRACT

A method for designing capacity of a compressed gas energy storage (CGES) system is provided. Existing design methods determine the rated power and capacity of compressor power, expander power, and volume of the high and low-pressure gas storage tanks, but fail to consider the operation of the power grid, leading to excessively high investment costs and low profits. The design method provided by the present disclosure can effectively avoid this issue. The system factors in local electricity prices, setting constraints to obtain a determined rated capacity and rated power of the CGES system, and the ROI for operating the CGES system. Based on rated capacity rated power, and taking key thermodynamic parameters of each system component as decision variables, a complete capacity and component size of the CGES system can be derived.

### TECHNICAL FIELD

The present disclosure relates to the field of compressed gas energy storage systems, particularly a method for designing capacity of a compressed gas energy storage (CGES) system.

### BACKGROUND

With the rapid advancement of technology and the economy, global demand for energy continues to increase. To meet growing energy demand, renewable energy has become a primary energy source, with wind and solar power accounting for the largest share. However, the intermittent and uncertain nature of these resources creates significant challenges for safety and stability of power grids. Energy storage is employed to mitigate these challenges. Representative large-capacity energy storage technologies include battery energy storage, pumped hydro energy storage, and CGES. CGES systems can be classified into compressed air energy storage and compressed carbon dioxide energy storage, depending on the working mass. A typical CGES system comprises a low-pressure gas tank, a compressor, a high-pressure gas tank, and an expander. During periods of surplus power supply, gas in the low-pressure tank is compressed and transferred to the high-pressure tank, converting electrical energy into internal energy for storage. During periods of power shortage, the high-pressure gas is released to drive the expander, which powers a generator to produce electricity, thereby converting internal energy back into electrical energy for supply. In this manner, the system both enhances grid stability and harvest economic arbitrage by leveraging price differences.

Current development of CGES systems presents the following problem:
1. Existing demonstration CGES systems are primarily designed according to a target compression power and an expected capacity of energy storage; the design of existing demonstration CGES systems begins from determining the charging power of the CGES system, i.e., the rated power of the compressor, and the capacity of energy storage, i.e., the duration of charging. Electricity prices are not considered in the system design.
2. The capacities of the expander, low pressure gas storage, and high-pressure gas storage are then determined according to an ideal thermodynamic cycle. This approach assumes that the pressure ratio remains constant during the compression and expansion processes and that all working mass could be utilized in charging and discharging processes. However, the pressure ratio constantly changes with the remained volume of working mass in the high- and low-pressure gas storage; additionally, a portion of working mass cannot be utilized due to the properties of the compressor and the expander. As a result, current design approaches often result in suboptimal capacity sizing, and the absence of an optimal capacity design method leads to either excessive initial investment or insufficient economic return. Accordingly, there is a recognized need for a systematic design methodology to determine the optimal capacity sizing of CGES systems.

### SUMMARY

An objective of the present disclosure is to provide a method for designing a compressed gas energy storage system. Existing design methods determine the rated power and capacity of the compressor power, the expander power, and the volumes of the high- and low-pressure gas storage tanks, while do not consider the operation of the power grid, leading to excessively high investment costs and low profits. The design method provided by the present disclosure can effectively avoid this issue.

In order to achieve the above objective, the present disclosure provides a method for designing the capacity of a CGES system, including the following steps:
S1, constructing a compressed gas energy storage system, based on local electricity prices, developing the first optimization problem with the objective of maximizing the return on investment (ROI) of the CGES system, taking rated capacity, rated power, and real-time power of the CGES system as decision variables; wherein the decision variables are determined by solving the optimization problem;
S2, based on the rated capacity and rated power, developing the second optimization problem with the objective of maximizing the round-trip efficiency (RTE) of the CGES system, taking key thermodynamic parameters of system components as decision variables, determining the volumes of the high- and low-pressure gas storage tanks according to the key thermodynamic parameters, thereby obtaining a complete capacity and a component size of the CGES system.

In some embodiments, the components of a CGES system include a compressor, an expander, a high-pressure gas storage tank, a low-pressure gas storage tank, a motor, a generator, an intercooler, and a heater.

In some embodiments, the constraints include pressure ratio constraints of the compressor and the expander, charging and discharging state constraints, and state of charge (SOC) constraints of the CGES system.

In some embodiments, in step S1, including the following steps:
S11, based on local electricity prices, developing the first optimization problem with the objective of maximizing the ROI of the CGES system, and taking rated capacity, rated power, and real-time power of the CGES as decision variables;
S12, establishing a mixed integer linear programming (MILP) model satisfying charging and discharging state constraints and SOC constraints, and solving the optimization problem using the Gurobi solver;
S13, if the iteration termination condition is satisfied, outputting the rated capacity and rated power, the real-time charging and discharging power, and SOCs of the CGES system; if the iteration termination condition is not satisfied, returning to step S12.

In some embodiments, in step S2, including the following steps:
S21, based on the rated capacity and rated power, setting an initial configuration of the CGES system, and establishing the CGES system model;
S22, establishing the second optimization problem in a genetic algorithm format with the objective of maximizing the RTE of the CGES system, taking key thermodynamic parameters as decision variables;
S23, after selecting, crossing, and mutating the genetic algorithm, obtaining an individual with maximum fitness, which corresponds to the highest RTE;
S24, calculating the key thermodynamic parameters of each system component, refining the rated power of the compressor and determining the heat transfer rate and the flow rate of the working gas;
S25, if Wₑₓₚ=E_{CGES,rate}, calculating the capacity of energy storage and the duration of charging and discharging; if the condition Wₑₓₚ-E_{CGES,rate} is not satisfied, returning to step S23;
S26, if the flow rate of working gas in the charging process equals to that in the discharging process, calculating the density and the volumes of the high- and the low-pressure gas storage tanks; if the flow rate of working gas in the charging process does not equal to that in the discharging process, returning to step S23.

In some embodiments, the key thermodynamic parameters, which have important influence on the RTE of the CGES system, include the outlet temperature of the compressor, the inlet temperature of the expander, the inlet pressure of the compressor, and the inlet pressure of the expander.

In some embodiments, the system for designing capacity of a CGES system includes the follows:
a system's capacity determination module, configured for constructing a CGES system, based on local electricity prices, developing the first optimization problem with the objective of maximizing the ROI of the CGES system, taking rated capacity, rated power, and real-time power of the CGES system as decision variables, wherein the decision variables are determined by solving the optimization problem;
a components' capacity calculation module, configured for determining the capacities of each system component, developing the second optimization problem in a genetic algorithm format with the objective of maximizing the RTE of the CGES system, taking key thermodynamic parameters as decision variables, refining the rated power of the compressor power and determining the heat transfer rate and the flow rate of the working gas, wherein the decision variables are determined by solving the genetic algorithm.

An electronic device, including a memory and a processor, wherein a computer program is stored in the memory, and the processor implements the design method in the memory to determine the capacity of each component in a CGES system.

A storage medium, the storage medium stores computer-executable instructions, and when the computer-executable instructions are loaded and executed by the processor, the steps of a method for determining the capacity of a CGES system are implemented.

Therefore, the present disclosure adopts the method for designing the capacity of the CGES system, which is connected to the power grid for profit arbitrage. The rated power of the compressor power and the expander and the volumes of the high- and low-pressure gas storage tanks have been determined. The design method provided by the present disclosure can effectively avoid the issue of excessively high investments and low profits by considering local electricity prices and CGES system operational dynamics into the design process.

### BRIEF DESCRIPTION OF THE DRAWINGS

FIG. 1 is a schematic diagram of a CGES system (grid-connected);

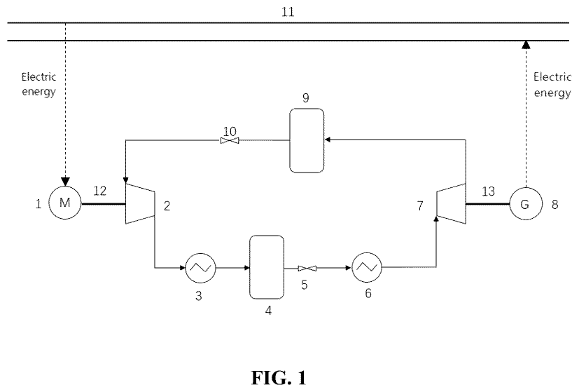

FIG. 2 is a flowchart of step S1;

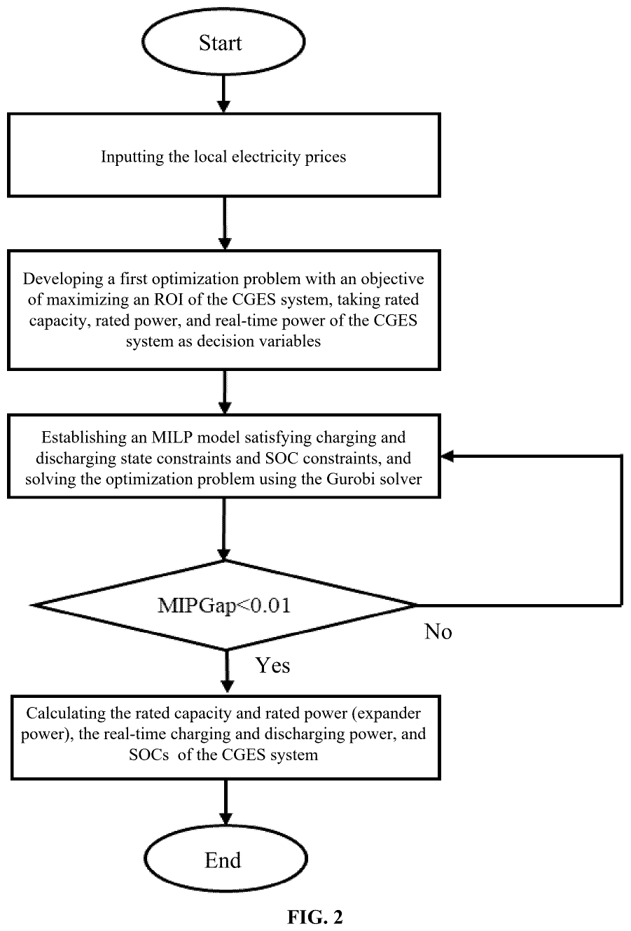

FIG. 3 is a flowchart of step S2.

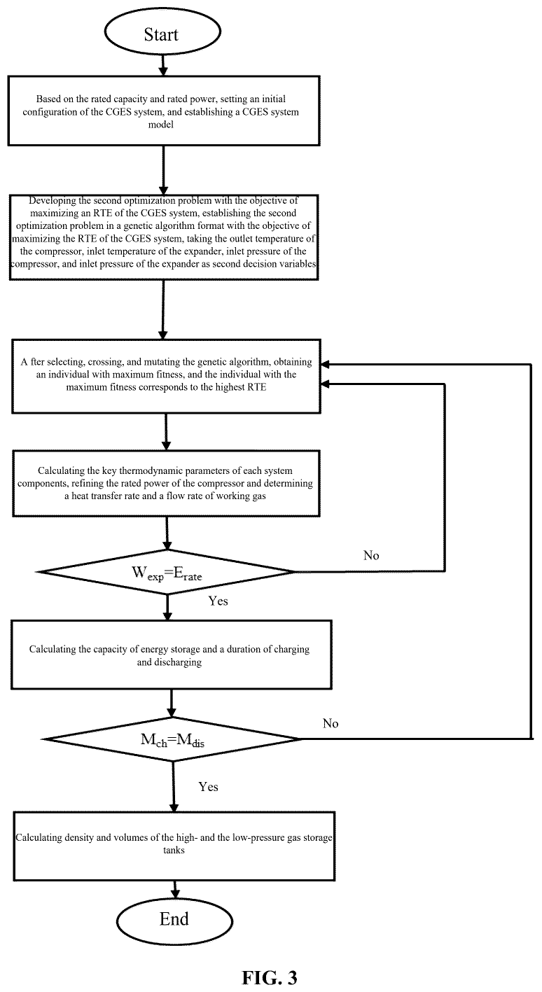

Reference numerals in FIGS.
1, a motor; 2, a compressor; 3, an intercooler; 4, a high-pressure gas storage tank; 5, a first valve; 6, a heater; 7, an expander; 8, a generator; 9, a low-pressure gas storage tank; 10, a second valve; 11, a grid; 12, a first coupling; 13, a second coupling.

### DETAILED DESCRIPTION OF THE EMBODIMENTS

The technical scheme of the present disclosure is further explained below by drawings and embodiments.

Unless otherwise defined, the technical or scientific terms used in the present disclosure shall be those to which the present disclosure belongs.

The specific operation principle of CGES system: in the period of low electricity price, a second valve 10 is controlled to open, a first valve 5 is controlled to close, the power from the power grid 11 supplies to the motor 1, the motor 1 drives a first coupling 12 to drive the compressor 2 to compress the low pressure gas from the low-pressure gas storage tank 9, when the high-temperature and high-pressure gas flow through an intercooler 3 is cooled, the heat is recovered, the gas finally enters the high-pressure gas storage tank 4, and the energy storage process is completed.

During the peak period of electricity price, the first valve 5 is controlled to open, the second valve 10 is controlled to close, and the gas in the high-pressure gas storage tank is released. After the heater 6 is heated to improve the power capacity, the high-temperature and high-pressure gas drives the expander to do work, which drives the second coupling 13 to drive the generator 8 to transmit power to the grid 11. After working, the gas enters the low-pressure gas storage tank 9, and the energy release process is completed.

### Embodiment 1

The present disclosure provides a method for designing capacity of a CGES system, including the following steps:
S1, the CGES system is constructed, based on local electricity prices, the first optimization problem with the objective of maximizing the ROI of the CGES system is developed, the rated capacity, rated power, and real-time power of the CGES system is taken as decision variables, and constraint conditions are set to solve the first objective function with the maximum return on investment; wherein the decision variables are determined by solving the optimization problem; the CGES system is composed of the compressor, the expander, the high-pressure gas storage tank, the low-pressure gas storage tank, the motor, the generator, the intercooler, and the heater.

Step S1 includes the following steps:
S11, based on the local electricity prices, the first optimization problem with the objective of maximizing the ROI of the CGES system is developed, the first optimization problem includes real-time energy storage power (W_{exp,t}, W_{com,t}), rated power E_{CGES,rate} rated capacity C_{CGES,rate}, and the rated capacity, rated power, and real-time power of the CGES system is taken as decision variables;
wherein the ROI of the first optimization problem is shown in Formula (1)

$$max ROI = \frac{{I}_{total}}{{C}_{total}} ; \qquad ( 1 )$$

where ROI is the return on investment, Iₜₒₜₐₗ is the total profit of the CGES system in one year, Cₜₒₜₐₗ is the total investment cost, and the total profit and total investment cost are shown in Formula (2) and Formula (3):

$${I}_{total} = {\sum }_{i = 1}^{8760} {v}_{dis , t} \cdot {W}_{ex p , t} \cdot {p}_{t} - {v}_{ch , t} \cdot {W}_{com , t} \cdot {p}_{t} ; \qquad ( 2 )$$

where, v_{ch,t} and v_{dis,t} represent the state of charging and discharging respectively, W_{exp,t} and W_{com,t} represent the real-time power of expander and compressor respectively, and pₜ represents the real-time electricity price.

$${C}_{t o t a l} = {E}_{CGES , rate} \cdot {IC}_{p} + {C}_{CGES , rate} \cdot {IC}_{s} + {C}_{O \& M} ; \qquad ( 3 )$$

where E_{CGES,rate} and C_{CGES,rate} are the rated power and rated capacity of the CGES system, ICₑ and ICₛ are the investment coefficients related to the rated power and rated capacity, respectively, and C_{O&M} is the operation and maintenance cost. Wherein the investment coefficient and operation and maintenance cost can be shown by Formula (4), Formula (5) and Formula (6).

$$I {C}_{p} = l n {v}_{p} \frac{{r ( 1 + r )}^{l}}{{( 1 + r )}^{l} - 1} ; \qquad ( 4 )$$

$$I {C}_{s} = l n {v}_{s} \frac{{r ( 1 + r )}^{l}}{{( 1 + r )}^{l} - 1} ; \qquad ( 5 )$$

$${C}_{O \& M} = {E}_{CGES , rate} \cdot {r}_{O \& M} ; \qquad ( 6 )$$

where lnvₚ and lnvₛ are the unit rated power and the unit capacity one-time mounting cost, respectively, r is the discount rate, l is the service life, and r_{O&M} is the operation and maintenance cost coefficient.

S12, the MILP model satisfying charging and discharging state constraints and SOC constraints is established, and the optimization problem is solved using the Gurobi solver.

The constraints include pressure ratio constraints of the compressor and the expander, charging and discharging state constraints, and SOC constraints of the CGES system.

The constraints of the MILP model of charging and discharging state constraints and SOC constraints are as follows:

the power constraints of the compressor and the expander, the expression is as follows:

$$0 \leq {W}_{ex p , t} \leq {E}_{C GES , rate} , \qquad ( 7 )$$

$$0 \leq {W}_{com , t} \leq {E}_{C GES , rate} ; \qquad ( 8 )$$

for charging and discharging state constraints, the CGES system has three states: energy storage, energy release, and standby. The constraint expressions are as follows:

$${v}_{dis , t} ∈ \{ 0 , 1 \} ; \qquad ( 9 )$$

$${v}_{ch , t} ∈ \{ 0 , 1 \} ; \qquad ( 10 )$$

$${v}_{dis , t} + {v}_{ch , t} \leq 1 ; \qquad ( 11 )$$

for the SOC constraints of the CGES system, the expression is as follows:

$$S O {C}_{m i n} \leq SOC \leq SO {C}_{ma x} ; \qquad ( 12 )$$

the local electricity prices data, the first optimization problem and the constraint conditions are input into the Gurobi solver to solve the first optimization problem with the objective of maximizing the ROI.

S13, if the iteration termination condition MIPGap<0.01 is satisfied, the rated capacity C_{CGES,rate} and rated power E_{CGES,rate}, the real-time charging and discharging power (W_{exp,t}, W_{com,t}), and the SOCs of the CGES system are output; if MIPGap≥0.01, returns to step S12.

The SOC expression of the CGES system is as follows:

$$S O {C}_{t + 1} = S O {C}_{t} + \frac{( {v}_{ch , t} ▯ {W}_{com , t} / {η}_{c o m} - {v}_{ch , t} ▯ {W}_{ex p , t} {▯η}_{ex p} ) ▯Δ t}{{C}_{cces , rate}} ; \qquad ( 13 )$$

where η_{com} represents the RTE of the compressor, and ηₑₓₚ represents the RTE of the expander; both are typically constant values.

S2, based on the rated capacity and rated power, the second optimization problem with the objective of maximizing the RTE of the CGES system is developed, the key thermodynamic parameters of system components are taken as decision variables, the volumes of the high- and low-pressure gas storage are determined according to the key thermodynamic parameters, thereby obtaining the complete capacity and the component size of the CGES system.

Step S2 includes the following steps:
S21, based on the rated capacity and rated power, the initial configuration of the CGES system is set, and the CGES system model is established;
S22, the second optimization problem in a genetic algorithm format with the objective of maximizing the RTE of the CGES system is established, the key thermodynamic parameters are taken as decision variables; the key thermodynamic parameters, which have important influence on the RTE of the CGES system, include the outlet temperature of the compressor, the inlet temperature of the expander, the inlet pressure of the compressor, and the inlet pressure of the expander.

The RTE of the CGES system is shown in Formula (14):

$${η}_{R T E} = \frac{{W}_{e x p}}{{W}_{c o m} + {Q}_{h e} - {Q}_{r e}} ; \qquad ( 14 )$$

where Wₑₓₚ is the total amount of energy discharged for electricity generation, W_{com} is the total energy of compression, Qᵣₑ is the compression heat recovered by the intercooler, and Qₕₑ is the heat input before expansion.

S23, after selecting, crossing and mutating the genetic algorithm, the individual with the maximum fitness is obtained, which corresponds to the highest RTE;

S24, the key thermodynamic parameters of each system component are calculated, and the rated power of the compressor is refined, the heat transfer rate and the flow rate of the working gas (flow rate of energy storage m_{ch} and flow rate of energy release m_{dis}) are determined;
the compressor power and expander power are shown as follows:

$${W}_{c o m} = {m}_{c h} \cdot ( {h}_{com , out} - {h}_{com , i n} ) ; \qquad ( 15 )$$

$${W}_{e xp} = {m}_{dis} \cdot ( {h}_{ex p , i n} - {h}_{ex p , out} ) ; \qquad ( 16 )$$

where m_{ch} and m_{dis} are the flow rate of energy storage and flow rate of energy release, respectively, h_{com,in} and h_{com,out} are the inlet and outlet enthalpy values of the compressor, respectively, and h_{exp,in} and h_{exp,out} are the inlet and outlet enthalpy values of the expander, respectively. The enthalpy values of the compressor and the expander can be called from the refpropm physical property library, and the thermodynamic parameters of each component of the CGES system are used for query. For example, the calculation of the enthalpy value of the compressor inlet is shown as follows:

$${h}_{com , i n} = f ( {T}_{com , i n} , {P}_{com , i n} ) ; \qquad ( 17 )$$

T_{com,in} represents the inlet temperature of the compressor, and P_{com,in} represents the inlet pressure of the compressor.

The remaining thermodynamic parameters can be calculated using the refpropm physical property library.

The heat transfer rate is shown as follows:

$$Q = {m}_{gas} \cdot \vert {h}_{out , gas} - {h}_{i n , gas} \vert ; \qquad ( 18 )$$

The heat calculation of the intercooler and the heater is shown in the above formula, where m_{gas} gas is the gas flow rate through the heat exchanger, h_{in,gas} and h_{out,gas} are the enthalpy values of the gas at the heat exchanger inlet and outlet.

S25, if Wₑₓₚ=E_{CGES,rate}, the capacity of energy storage and the duration of charging and discharging are calculated; if the condition Wₑₓₚ=E_{CGES,rate} is not satisfied, returns to step S23.

The rated power and capacity of energy storage have been determined. Therefore, in the genetic algorithm for optimizing the RTE, the general rated power is the expander power, and the expander power is limited to a certain value by adjusting the flow rate of energy release. Additionally, the capacity of energy storage is used to calculate the energy storage release time, as shown in the following formula:

$${t}_{ch} = \frac{{C}_{CGES , rate}}{{W}_{CGES , rate}} ; \qquad ( 19 )$$

$${t}_{ch} = \frac{{C}_{CGES , rate}}{{W}_{CGES , rate}} . \qquad ( 20 )$$

In the cycle operation of the CGES system, it should be ensured that the total mass of the gas in the charging process equals to that in the discharging process, and the mathematical expression is as follows:

$${M}_{t o t a l} = {m}_{c h} \cdot {t}_{c h} = {m}_{dis} \cdot {t}_{dis} ; \qquad ( 21 )$$

$${M}_{c h} = {m}_{c h} \cdot {t}_{c h} ; \qquad ( 22 )$$

$${M}_{dis} = {m}_{dis} \cdot {t}_{dis} ; \qquad ( 23 )$$

S26, when M_{ch}=M_{dis}, the density and the volumes of the high- and the low-pressure gas storage tanks are calculated; otherwise, returns to step S23.

During the genetic operation process, the flow rates of the expander and compressor should be continuously adjusted to satisfy the constraints. The population of the genetic algorithm is selected, crossed, and mutated to ultimately obtain the individual with the maximum fitness, which corresponds to the highest RTE. At this time, the key thermodynamic parameters of each system component under the highest RTE are obtained. The compressor power, heat transfer rate, flow rate of energy storage, and flow rate of energy release can be obtained through calculation.

The total mass of the cycle process is calculated by Formula (20). The optimized key thermodynamic parameters of the CGES system obtained via the genetic algorithm are used to call the refpropm property library, yielding the gas density of the high- and the low-pressure gas storage tanks. The volumes of the high- and the low-pressure gas storage tanks are then calculated by using the following formula:

$${V}_{hpt} = \frac{{M}_{total}}{{ρ}_{hpt , gas}} ; \qquad ( 24 )$$

$${V}_{lpt} = \frac{{M}_{total}}{{ρ}_{lpt , gas}} ; \qquad ( 25 )$$

where Vₕₚₜ and Vₗₚₜ represent the volumes of the high- and the low-pressure gas storage tanks, respectively, and ρ_{hpt,gas} and ρ_{ipt,gas} represent the density of the high- and the low-pressure gas storage tanks, respectively.

A system for designing capacity of a CGES system, the system includes the following:
a system's capacity determination module, configured for constructing a CGES system, based on local electricity prices, developing the first optimization problem with the objective of maximizing the ROI of the CGES system, taking rated capacity, rated power, and real-time power of the CGES system as decision variables, wherein the decision variables are determined by solving the optimization problem;
a components' capacity calculation module, configured for determining the capacities of each system component, developing the second optimization problem in a genetic algorithm format with the objective of maximizing the RTE of the CGES system, taking key thermodynamic parameters as decision variables, refining the rated power of the compressor power and determining the heat transfer rate and the flow rate of the working gas, wherein the decision variables are determined by solving the genetic algorithm.

The electronic device provided by the present disclosure includes a processor, a memory, and a computer program stored in the memory and capable of running on the processor. The processor implements the steps of the embodiments in the above method when executing the computer program. Or, when the processor executes the computer program, it achieves the function of each module/unit of the embodiments in the above device.

The computer program may be divided into one or more modules/units, wherein one or more modules/units are stored in the memory and executed by the processor to achieve the present disclosure.

The device may be computing equipment such as desktop computers, laptops, handheld computers, and cloud servers. The terminal device may include, but is not limited to, a processor and memory.

The processor may be a Central Processing Unit (CPU), or it may be other general-purpose processors, Digital Signal Processors (DSPs), Application-Specific Integrated Circuits (ASICs), Field-Programmable Gate Arrays (FPGAs), or other programmable logic devices, discrete gates or transistor logic devices, discrete hardware components, etc.

The memory may be used to store the computer program and/or module, wherein the processor implements various functions of the terminal device by running or executing the computer program and/or module stored within the memory, as well as by calling upon data stored within the memory.

The terminal device integration modules/units may be stored on a computer-readable storage medium when implemented as software functional units and sold or used as a separate product. Based on this understanding, the present disclosure may implement all or part of the processes described in the above embodiments through computer programs that command relevant hardware. Such computer programs may be stored on a computer-readable storage medium, and when the computer program is executed by a processor, it may implement the steps of the embodiments of the above methods. Wherein, the computer program includes computer program code, which may be in the form of source code, object code, executable files, or certain intermediate forms. The computer-readable medium may include: any entity or device capable of carrying the computer program code, recording media, USB drives, portable hard drives, magnetic disks, optical disks, computer memory, read-only memory (ROM), random access memory (RAM), electrical carrier signals, telecommunication signals, and software distribution media. It should be noted that the contents of the computer-readable medium described herein may be appropriately modified or supplemented as required by the legislation and patent practices of a particular jurisdiction. For example, in certain jurisdictions, computer-readable media may not include electrical carrier signals or telecommunications signals under applicable legislation and patent practices.

Therefore, the present disclosure adopts the method for designing the capacity of the CGES system. Existing design methods determine the rated power and capacity of the compressor power, the expander power and the volume of the high- and low-pressure gas storage tanks have been determined, while do not consider the operation of the power grid, leading to excessively high investment costs and low profits. The design method provided by the present disclosure can effectively avoid this issue.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A method for designing capacity of a CGES system, comprising the following steps:
S1, constructing a CGES system, based on local electricity prices, developing a first optimization problem with an objective of maximizing an ROI of the CGES system, and taking rated capacity, rated power, and real-time power of the CGES system as decision variables wherein the decision variables are determined by solving the optimization problem; and
S2, based on the rated capacity and rated power, developing a second optimization problem with an objective of maximizing an RTE of the CGES system, and, taking key thermodynamic parameters of each system component as decision variables, determining the volumes of high- and low-pressure gas storage tanks according to key thermodynamic parameters, thereby obtaining a complete capacity and component size of the CGES system.

2. The method for designing the capacity of the CGES system according to claim 1, wherein the components of the CGES system comprise a compressor, an expander, the high-pressure gas storage tank, the low-pressure gas storage tank, a motor, a generator, an intercooler, and a heater.

3. The method for designing the capacity of the CGES system according to claim 1, wherein the constraints comprise pressure ratio constraints of the compressor and the expander, charging and discharging state constraints, and SOC constraints of the CGES system.

4. The method for designing the capacity of the CGES system according to claim 1, wherein step S1, comprises the following steps:
S11, based on the local electricity prices, developing the first optimization problem with the objective of maximizing the ROI of the CGES system, and taking the rated capacity, the rated power, and the real-time power of the CGES as decision variables;
S12, establishing an MILP model satisfying charging and discharging state constraints and SOC constraints, and solving the optimization problem using a Gurobi solver; and
S13, if an iteration termination condition is satisfied, outputting the rated capacity and rated power, the real-time charging and discharging power, and SOCs of the CGES system, and if the iteration termination condition is not satisfied, returning to step S12.

5. The method for designing the capacity of the CGES system according to claim 1, wherein step S2, comprises the following steps:
S21, based on the rated capacity and rated power, setting an initial configuration of the CGES system, and establishing a CGES system model;
S22, establishing the second optimization problem in a genetic algorithm format with the objective of maximizing the RTE of the CGES system, taking the key thermodynamic parameters as second decision variables;
S23, after selecting, crossing, and mutating the genetic algorithm, obtaining an individual with maximum fitness, wherein the individual with the maximum fitness corresponds to the highest RTE;
S24, calculating the key thermodynamic parameters of each system component, refining the rated power of the compressor and determining a heat transfer rate and a flow rate of working gas;
S25, if Wₑₓₚ=E_{CGES,rate}, calculating the capacity of energy storage and a duration of charging and discharging, and, if the condition Wₑₓₚ=E_{CGES,rate} is not satisfied, returning to step S23; and
S26, if the flow rate of working gas in the charging process equals to that in the discharging process, calculating the density and volumes of the high- and the low-pressure gas storage tanks, and, if the flow rate of working gas in the charging process does not equal to that in the discharging process, returning to step S23.

6. The method for designing the capacity of the CGES system according to claim 1, wherein the key thermodynamic parameters that have a significant influence on the RTE of the CGES system comprise outlet temperature of the compressor, inlet temperature of the expander, inlet pressure of the compressor, and inlet pressure of the expander.

7. A system for designing capacity of a CGES system, comprising:
a system capacity determination module, configured for constructing a CGES system, based on local electricity prices, developing a first optimization problem with an objective of maximizing an ROI of the CGES system, and taking rated capacity, rated power, and real-time power of the CGES system as decision variables, wherein the decision variables are determined by solving the optimization problem;
a component capacity calculation module, configured for determining the capacities of each system component, developing the second optimization problem in a genetic algorithm format with an objective of maximizing an RTE of the CGES system, taking key thermodynamic parameters as decision variables, refining the rated power of the compressor power, and determining a heat transfer rate and a flow rate of the working gas, wherein the decision variables are determined by solving the genetic algorithm.

8. An electronic device, comprising a memory and a processor, wherein a computer program is stored in the memory, and the processor calls the computer program in the memory to implement the steps of a method for designing the capacity of the CGES system according to claim 1.

9. A storage medium, wherein the storage medium stores computer-executable instructions, and when the computer-executable instructions are loaded and executed by the processor, the steps of the method for designing the capacity of the CGES system according to claim 1 is implemented.
